(19) United States
(12) Patent Application Publication
(10) Pub. No.: US 2017/0013201 A1
(43) Pub. Date: Jan. 12, 2017

(54) SYSTEMS AND METHODS FOR AUTOMATICALLY ADJUSTING VIEW ANGLES IN VIDEO

(71) Applicant: Chengdu CK Technology CO., LTD., Chengdu (CN)

(72) Inventor: Shu Liu, Chengdu (CN)

(21) Appl. No.: 15/155,913

(22) Filed: May 16, 2016

(30) Foreign Application Priority Data
Jul. 8, 2015 (CN) 201510395027X

(51) Int. Cl. H04N 5/232; G06T 7/00

(52) U.S. Cl. CPC H04N 5/23296; G06T 7/004; G06T 2207/10016; G06T 2207/20132

(57) ABSTRACT

The present technology is directed to systems and methods for maintaining a position of an objection-of-interest in a predetermined place in a video captured by a sports camera. The method includes positioning an object at a pre-determined location of an image interface of a camera (e.g., a view finder), starting to record a video, and periodically determining whether the object is at the pre-determined location by constantly calculating a view ratio of the object (e.g., a ratio of area that the object occupies to the whole view finder). If the view ratio does not change, then recording continues. If the view ratio changes, the method then adjusts the view angle of the camera by increasing or decrease a view angle of the camera. By doing so, the system enables a user of the sports camera to focus on filming a moving object in a pre-determined way.

### CROSS-REFERENCE TO RELATED APPLICATIONS

This application claims the benefit of Chinese Patent Application No. 201510395027X, filed Jul. 8, 2015 and entitled “A METHOD FOR AUTOMATICALLY ADJUSTING VIEW ANGLES AND RECORDING AFTER LOCKING A SCENE,” the contents of which are hereby incorporated by reference in its entirety.

### BACKGROUND

In recent years, sports cameras are more and more popular and widely used in various occasions, including filming a video of a moving object-of-interest, such as an animal or an athlete. Due to the movement of the object-of-interest, it is difficult to constantly keep the object-of-interest at a desirable position in the video. Traditionally, a user needs to manually adjust a view angle of the moving object-of-interest so as to modify the position of moving object-of-interest. However, it is inconvenient and sometimes even impractical for a user to do so especially when the object-of-interest is moving relatively fast. Therefore, it is beneficial to have a system and method that can effectively address this problem.

### BRIEF DESCRIPTION OF THE DRAWINGS

Embodiments of the disclosed technology will be described and explained through the use of the accompanying drawings.

FIG. 1 is a schematic block diagram illustrating a system in accordance with embodiments of the present disclosure.

FIG. 2 is a flow chart illustrating another method in accordance with embodiments of the present disclosure.

FIG. 3A is a schematic diagram illustrating an object-of-interest moving toward an image component and the corresponding changes of a view angle of the image component.

FIG. 3B is a schematic diagram illustrating an object-of-interest moving away from an image component and the corresponding changes of a view angle of the image component.

FIGS. 4A and 4B are schematic diagrams illustrating images shown in a user interface in accordance with embodiments of the present disclosure. An object-of interest has moved toward the image component from FIG. 4A to FIG. 4B.

The drawings are not necessarily drawn to scale. For example, the dimensions of some of the elements in the figures may be expanded or reduced to help improve the understanding of various embodiments. Similarly, some components and/or operations may be separated into different blocks or combined into a single block for the purposes of discussion of some of the embodiments. Moreover, although specific embodiments have been shown by way of example in the drawings and described in detail below, one skilled in the art will recognize that modifications, equivalents, and alternatives will fall within the scope of the appended claims.

### DETAILED DESCRIPTION

In this description, references to “some embodiment”, “one embodiment,” or the like, mean that the particular feature, function, structure or characteristic being described is included in at least one embodiment of the disclosed technology. Occurrences of such phrases in this specification do not necessarily all refer to the same embodiment. On the other hand, the embodiments referred to are not necessarily mutually exclusive.

The present disclosure is directed to a system that can create a video in which an object-of-interest is positioned at a predetermined location of the video. For example, the object-of-interest can be positioned in a center portion of the video (e.g., an area in the center when the video is visually presented via a display or a view finder). More particularly, the present disclosure provides a system and method for adjusting a view angle of an image component so as to maintain the position of the object-of-interest displayed in the video. For example, the system can be a sports camera. A user of the sports camera can determine an object-of-interest by viewing captured images through a view finder of the sports camera. Once the object-of-interest is determined (e.g., the user can locate a football player on a field), the user can slightly press a button of the camera, and then the camera will present an indicator on the view finder to indicate the object-of-interest. The indicator can be a frame, a shape (e.g., circle, rectangle, triangle, or square), or an outline (or a contour) of the object-of-interest. The indicator enclosures an area occupied by the object-of-interest, which can be used to calculate a view ratio of the object-of-interest. For example, if the system determines that the object-of-interest occupies 50% of the whole view finder (e.g., by a pixel-by-pixel calculation), then the view ratio is 50%.

In some embodiments, the system includes a scene analysis component configured to analyze capture images and automatically identify the object-of-interest in the captured images based on user configurations (e.g., search a captured image and identify a portion thereof that shows a person wearing a jersey). The scene analysis component can be further configured to constantly (or periodically) monitor the position of the object-of-interest. For example, the system can perform a set of instructions stored in a memory of the system that will notify a user when detecting a change of the view ratio (e.g., by detecting changes of the pixels associated with the object-of-interest). As another example, the system can periodically perform a routine or an application so as to check whether there is a change of the view ratio. By monitoring the view ratio, the scene analysis component can determine whether the object-of-interest is moving toward the image component (i.e., the view ratio increases) or away from the image component (i.e., the view ratio decreases).

The system also includes a view angle adjusting component configured to adjust a view angle of the image component based on the changes of the view ratio. For example, when the view ratio increases, the system will decrease the view angle of the image component (which accordingly makes an item in the view finder look smaller, so as to compensate the view ratio increase). On the other hand, when the view ratio decreases, the system will increase the view angle of the image component (which accordingly makes an item in the view finder look larger, so as to compensate the view ratio decrease). Accordingly, the system can adjust the view angle of the image component based on the analysis result generated by the scene analysis component.

By this arrangement, the system enables a user to generate a video with an object that locates at a predetermined location displayed in the video. For example, a user can create a video to record certain movements of an athlete, and the athlete will be always shown in the center of the video.

Advantages of the system includes that it enables a user to create images that focus on a certain object. It is convenient for the user to do so without requiring him/her to further edit the captured images. In addition, the system can provide such focused images in a real-time fashion, which enables the user to share captured images instantly. It is also beneficial that the system can save the user a significant amount of time spending on processing or editing the captured images.

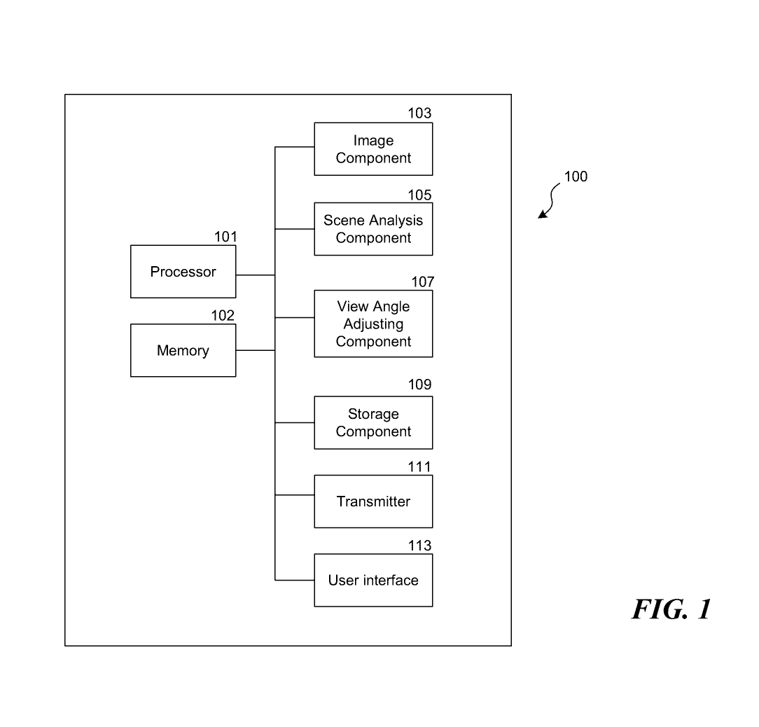

FIG. 1 is a schematic block diagram illustrating a system 100 in accordance with embodiments of the present disclosure. The system 100 includes a processor 101, a memory 102, an image component 103, a scene analysis component 105, a view angle adjusting component 107, a storage component 109, a transmitter 111, and a user interface component 113. The processor 101 is configured to control the memory 102 and other components (e.g., components 103-113) in the system 100. The memory 102 is coupled to the processor 101 and configured to store instructions for controlling other components in the system 100.

The image component 103 is configured to capture or collect images (pictures, videos, etc.) from ambient environments of the system 100. In some embodiments, the image component 103 can be a camera. In some embodiments, the image component 103 can be a video recorder. The scene analysis component 105 is configured to analyze images captured by the image component 103. In some embodiments, the scene analysis component 105 can be software, an application, a set of instructions, an algorithm or other suitable processes that can be implemented by the system. The scene analysis component 105 can first identify an object-of-interest in the captured images. In some embodiments, the scene analysis component 105 can perform a pixel-by-pixel comparison so as to identify an object-of-interest. In other embodiments, the scene analysis component 105 can identify an object-of-interest based on various factors such as a shape, a color, shadings, or other visual features of the object-of-interest. In some embodiments, the identified object-or-interest can be a portion of a moving article or person. For example, the identified object-or-interest can be a face of an actor. As another example, the identified object-or-interest can be a hand of a boxer. In one embodiment, the identified object-or-interest can be a headlight of a sports car.

After the object-of-interest is identified, the scene analysis component 105 can further calculate a view ratio of the object-of-interest in the captured images. In some embodiments, the view ratio can be an area percentage that the object-of-interest occupies in the whole captured image. For example, the view ratio can range from 10% to 90% of a captured image. In some embodiments, the view ratio can be calculated based on an area, a length, a width, or a diagonal line of an object-of-interest. In some embodiments, the view ratio can be calculated based on pixel counts. For example, an image captured by the image component 103 can have a pixel dimension of 1200×1200. An identified object-in-interest can have a pixel dimension of 400×600. In such embodiments, the area-based view ratio can be 1/6 ([400×600]/[1200×1200]). The width-based view ratio can be 1/3 (400/1200), and the length-based view ratio can be 1/2 (600/1200).

Once the view ratio is determined, the scene analysis component 105 can keep monitoring or tracking the view ratio of the object-of-interest. The scene analysis component 105 then compares the monitored view ratio with a default view ratio. In some embodiments, the default view ratio is an initial first view ratio (e.g., it can be set by a user when he/she starts to capture a set of images) for an object-of-interest calculated by the scene analysis component 105. In some embodiments, the default view ratio can be determined based on users' preferences. In other embodiments, the default view ratio can be determined based on types of captured images. For example, the system 100 can provide a default view ratio of 50% for captured images associated with an outdoor activity (e.g., skiing or mountain biking). As another example, the system 100 can provide a default view ratio of 70% for captured images associated with an indoor activity (e.g., figure skating or gymnastics).

In some embodiments, a view ratio change can be detected based on the following methods. Assume that the original view ratio is R1 and the current calculated view ratio is R2. In some embodiments, in an event that the difference between R1 and R2 is greater than a threshold value, the system 100 can determine that there is a view ratio change. For example, the original view ratio R1 can be 50%, the current calculated view ratio R2 can be 55%, and the threshold value can be 3%. In this example, the system 100 determines that there is a view ratio change because the difference between R1 and R2 (i.e., 55%−50%=5%) is greater than the threshold value 3%. In other examples, the difference between R1 and R2 can be further compared with R1 to obtain a percentage change of the original view ratio R1. For example, in an event that R1 increases or decreases more than a certain percentage, the system 100 can determine that there is a view ratio change. For example, the original view ratio R1 can be 40%, the current calculated view ratio R2 can be 44%, and the threshold value can be 5%. In this example, the view ratio has a 10% (4/40) increase which exceeds the threshold value 5%. In this example, the system 100 determines that there is a view ratio change.

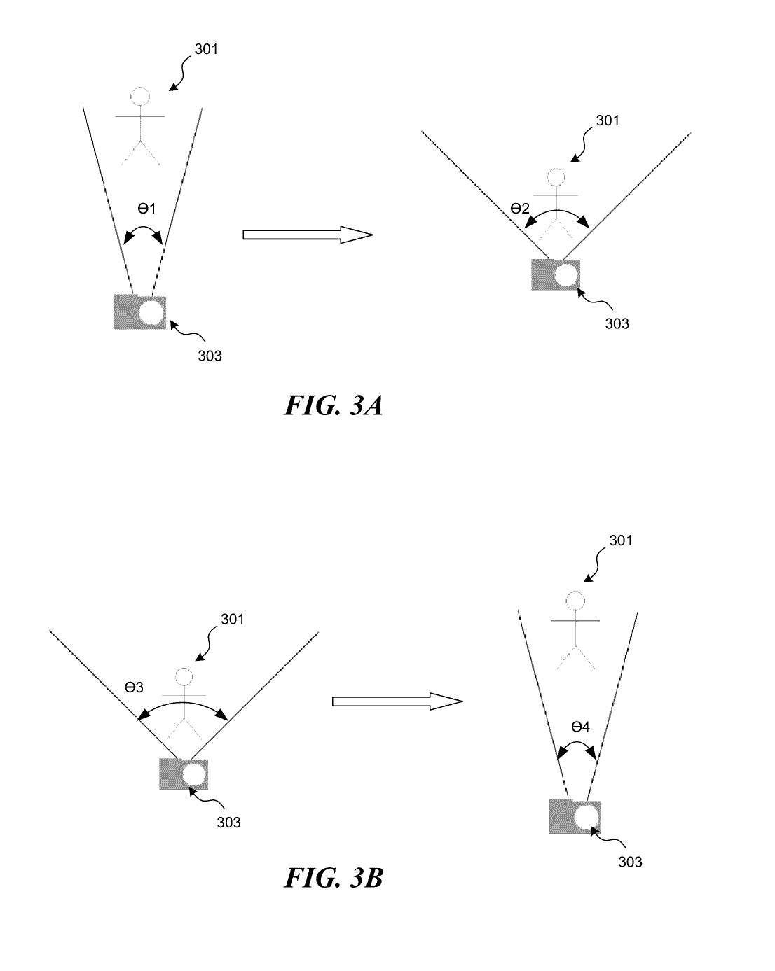

If there is no change of the view ratio, the image component 103 can keep capturing images. Once the scene analysis component 105 detects a change of the view ratio, the scene analysis component 105 will notify the view angle adjusting component 107 to adjust the current view angle of the image component 103 so as to keep the current view ratio substantially the same as the default view angle. Detailed discussion of the changes of the view angle can be found in FIGS. 3A and 3B and corresponding descriptions below.

If the scene analysis component 105 detects that the view ratio is increasing (namely, the object-of-interest is moving toward the image component 103), the scene analysis component 105 then notifies this change to the view angle adjusting component 107. In response to the notification, the view angle adjusting component 107 then decreases the current view angle so as to compensate the view ratio increase. As another example, if the scene analysis component 105 detects that the view ratio is decreasing (namely, the object-of-interest is moving away from the image component 103), the scene analysis component 105 then notifies this change to the view angle adjusting component 107. In response to the notification, the view angle adjusting component 107 then increases the current view angle so as to compensate the view ratio decrease. In some embodiments, the view angle adjusting component 107 can be software, an application, a set of instructions, an algorithm or other suitable processes that can be implemented by the system. By so doing, the system 100 can maintain the object-of-interest at a predetermined position in the captured images.

The storage unit 109 is configured to store, temporarily or permanently, captured images, system histories, files, and/or other suitable data/information/signals associated with the system 100. In some embodiments, the storage component 109 can be a hard disk drive. In some embodiments, the storage component 109 can be a memory stick or a memory card. The transmitter 111 is configured to transmit information (such as captured images) to a remote device/server via a network (e.g., a wireless connection). In some embodiments, the system 100 can be controlled remotely. In such embodiments, the transmitter 111 can be used to receive (e.g., acting as a receiver) control signals. The user interface 113 is configured to visually present the captured images with the object-of-interest. In some embodiments, the user interface component 113 can be a view finder. In some embodiments, the user interface 113 can be a display.

In some embodiments, if the object-of-interest not only moves toward or away from the image component 103, but also moves in other direction (e.g., the object-of-interest moves along a circular path whose center is the image component 103), the view angle adjusting component 107 can further edit (e.g., cut a portion thereof) the captured images so as to maintain the object-of-interest in at a predetermined position in the captured images.

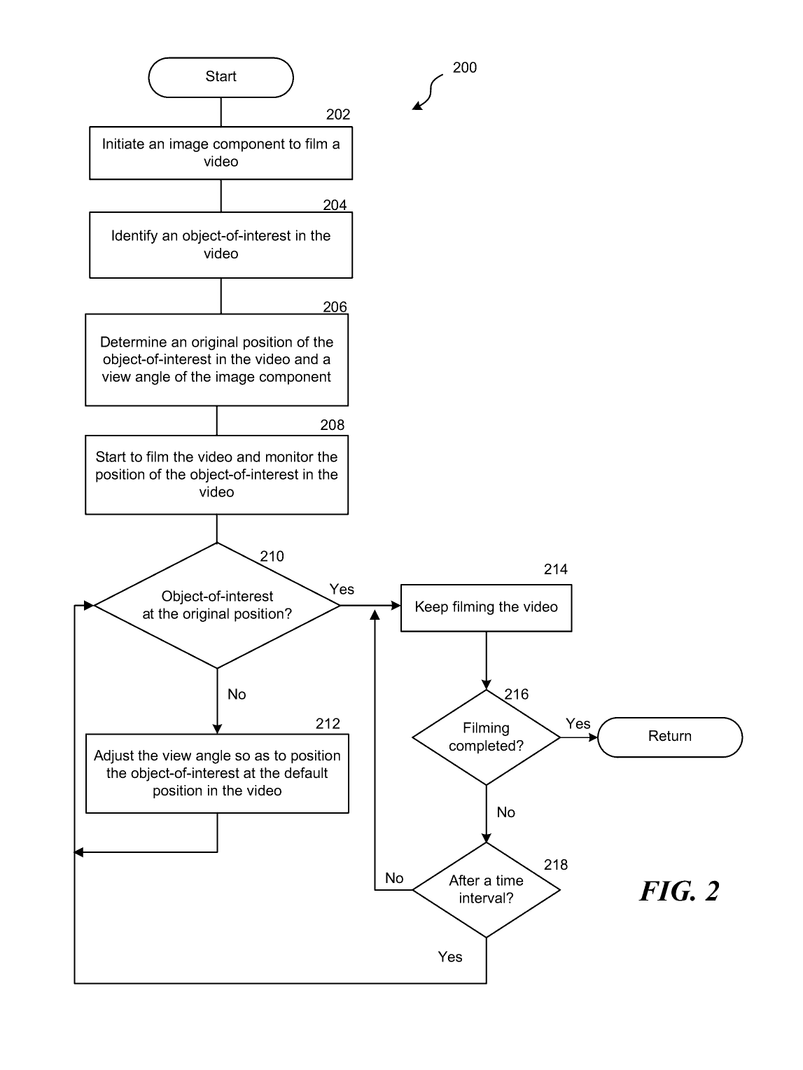

FIG. 2 is a flow chart illustrating another method 200 in accordance with embodiments of the present disclosure. The method 200 starts at block 202 by initiating an image component to film a video. At block 204, the system identifies an object-of-interest in the video. At block 206, the system then determines an original position of the object-of-interest in the video and a view angle of the image component. In some embodiments, the original position of the object-of-interest can be a place where the object-of-interest first shown in the video. In some embodiments, the original position of the object-of-interest can be determined based on user preferences, types of the object-of-interest, and/or other suitable factors. Detailed discussion for the view angle can be found at FIGS. 3A and 3B and corresponding descriptions below.

At block 208, the system starts to film the video and monitor the position of the object-of-interest in the video. The method 200 then moves to decision block 210 to determine whether the object-of-interest remains at the original position. If not, the process then continues to block 212. At block 212, the system adjusts the view angle of the image component so as to position the object-of-interest at the original position in the video. In some embodiments, when the current position of the object-of-interest is not substantially the same as the original position, the system can crop the video so as to position the object-of-interest at the original position in the video. After the adjustment, the process then goes back to decision block 210 to again determine whether the object-of-interest remains at the original position. If so, then the process continues to block 214 to keep filming the video.

The method 200 then continues to decision block 216 to determine whether the video is completed. If so, then the method 200 returns. If not, the process continues to block 218 where the system determines whether it has been a predetermined period of time (e.g., 10 second) since the last time that the system determines whether the object-of-interest was at the original position (e.g., block 210). If not, the process goes back to block 214 to keep filming the video. If so, the process goes back to block 210 to again determine whether the object-of-interest is at the original position.

FIG. 3A is a schematic diagram illustrating an object-of-interest 301 moving toward an image component 303 and the corresponding changes of a view angle of the image component 303. As shown in FIG. 3A, the object-of-interest 301 moves toward the image component 303. Accordingly, the view angle increases from θ1 to θ2. Similarly, FIG. 3B is a schematic diagram illustrating the object-of-interest 301 moving away from the image component 303 and the corresponding changes of the view angle of the image component 303. As shown in FIG. 3B, the object-of-interest 301 moves away from the image component 303. Accordingly, the view angle decreases from θ3 to θ4. It should be noted that reference points X1, X2, X3, X4, X5 and the reference mark 409 disclosed hereby are for the purpose of better understanding but not intended to limit the present technology.

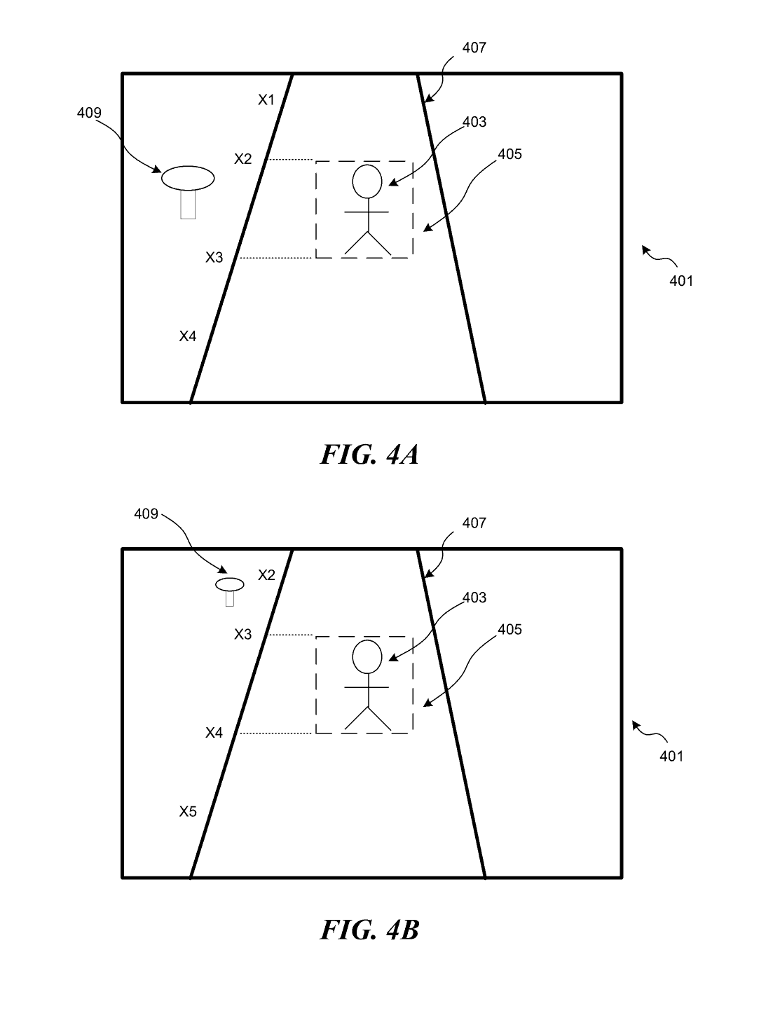

FIGS. 4A and 4B are schematic diagrams illustrating a user interface 401 showing images of a moving object-of-interest 403 captured by an image component. The user interface 401 shown in FIGS. 4A and 4B together illustrate a movement of the object-of-interest 403 toward the image component. In some embodiments, the user interface 401 can be visually presented in a view finder. In some embodiments, the user interface 401 can be visually presented in a display. In the illustrated embodiment, the object-of-interest 403 is moving along a path 407 toward the image component. The path 407 includes reference points X1, X2, X3, X4 and X5 indicating relative locations of the path 407. In addition, a reference mark 409 is located between the reference points X2 and X3.

As shown in FIG. 4A, at first, the object-of-interest 403 is positioned in a pre-determined area 405 of the user interface 401. In some embodiments, the system can directly identify the object-of-interest 403 without positioning it in the pre-determined area 405. The pre-determined area 405 is located adjacent to the reference mark 409 between the reference points X2 and X3. After a period of time, as shown in FIG. 4B, it is supposed that the object-of-interest 403 has moved from the reference point X3 to the reference point X4 along the path 407. During the movement of the object-of-interest 403, the user interface 401 keeps visually presenting the object-of-interest 403 in the predetermined area 405 of the user interface 401 and maintains a view ratio of the object-of-interest 403 (e.g., an area percentage that the object-of-interest 403 occupies in the whole user interface 401). In other words, the presentation of the objected-of-interest 403 is “locked” during its movement. Namely, the size of the object-of-interest 403 presented in the user interface 401 remains unchanged during the movement. As a comparison, the reference mark 409 is not “locked” during the movement. Therefore, the size of the reference mark 409 in FIG. 4B is smaller in the user interface 401 than is shown in FIG. 4A. By maintaining the size of the object-of-interest 403 presented in the user interface 401 (e.g., increase the view angle when the object-of-interest 403 moves away from the image component; decrease the view angle when the object-of-interest 403 moves toward the image component), the system of the present disclosure provides a user a set of images that visually present the object-of-interest 403 in a constant way during filming the video. The system enables a user to easily track or observe the object-of-interest 403.

Although the present technology has been described with reference to specific exemplary embodiments, it will be recognized that the present technology is not limited to the embodiments described but can be practiced with modification and alteration within the spirit and scope of the appended claims. Accordingly, the specification and drawings are to be regarded in an illustrative sense rather than a restrictive sense.

1. A method for filming a video, comprising:
initiating an image component to film the video;
identifying an object-of-interest in the video;
determining an original position of the object-of-interest in the video;
determining an original view angle associated with the object-of-interest;
starting to film the video of the object-of-interest;
monitoring a current position of the object-of-interest in the video;
determining whether the current position is substantially the same as the original position; and
in an event that the current position is not substantially the same as the original position, adjusting a view angle so as to position the object-of-interest at the original position in the video.

2. The method of claim 1, further comprising:
positioning the object-of-interest at the original position in the video; and
when the current position is not substantially the same as the original position, cropping the video so as to position the object-of-interest at the original position in the video.

3. The method of claim 2, further comprising:
determining an original view angle associated with the object-of-interest; and
positioning the object-of-interest at the original position in the video.

4. The method of claim 3, further comprising determining a view ratio of the object-of-interest based on a ratio of the default area to the user interface.

5. The method of claim 4, further comprising maintaining the view ratio of the object-of-interest when filming the video.

6. The method of claim 4, wherein the ratio is an area ratio.

7. The method of claim 4, wherein the ratio is a length ratio.

8. The method of claim 4, wherein the ratio is a width ratio.

9. The method of claim 4, wherein the ratio is a diagonal ratio.

10. A system for positioning an object-of-interest in a video, comprising:
a processor;
an image component coupled to the processor and configured to generating a set of images having the object-of-interest positioned therein, wherein the image component generates the set of image at a view angle;
a scene analysis component coupled to the processor and configured to analyze the set of images so as to determine a current view ratio of the object-of-interest, wherein the current view ratio is determined based on a ratio between the object-of-interest to the set of images, and wherein the scene analysis component is further configured to monitor the current view ratio of the object-of-interest; and
a view angle adjusting component coupled to the processor and configured to adjust the view angle at least based on a comparison between the current view ratio and a predetermined view ratio.

11. The system of claim 10, further comprising:
a storage component configured to store the set of images; and
a user interface configured to visually present the set of images.

12. The system of claim 10, further comprising a transmitter configured to transmit the set of images to a remote device via a network.

13. The system of claim 10, wherein the ratio is an area ratio.

14. The system of claim 10, wherein the ratio is a length ratio.

15. The system of claim 10, wherein the ratio is a width ratio.

16. The system of claim 10, wherein the ratio is a diagonal ratio.

17. A method for visually presenting a moving object-of-interest, comprising:
initiating an image component to generate a set of images associated with the object-of-interest;
identifying an object-of-interest in the set of images;
determining an initial area occupied by the object-of-interest in the set of images;
determining an initial view angle of the image component;
monitoring the initial area based on a pixel-by-pixel analysis of the set of images; and
adjusting the initial view angle in response to a result of monitoring the initial area.

18. The method of claim 17, wherein adjusting the initial view angle includes:
in response to an event that the initial area increases, decreasing the initial view angle.

19. The method of claim 17, wherein adjusting the initial view angle includes:
in response to an event that the initial area decreases, increasing the initial view angle.

20. The method of claim 17, wherein the initial area is determined based on a shape of the object-of-interest.
